(19) United States
(12) Patent Application Publication
(10) Pub. No.: US 2021/0284767 A1
(43) Pub. Date: Sep. 16, 2021

(54) Process for Preparing Polyethylene

(71) Applicant: Total Research & Technology Feluy

(72) Inventors: Alexandre Welle, Court-St-Etienne (BE); Aurélien Vantomme, Mignault (BE); Jean-François Carpentier, Acigné (FR); Gilles Schnee, Montpellier (FR); Olivier Miserque, Mont-Saint-Guibert (BE); Evgueni Kirillov, Cesson Sevigne (FR)

(21) Appl. No.: 16/330,641

(22) PCT Filed: Sep. 7, 2017
(86) PCT No.: PCT/EP2017/072396

§ 371 Date: Mar. 5, 2019

(30) Foreign Application Priority Data
Sep. 8, 2016 (EP) 16290169.8

(51) Int. Cl. C08F 110/02; C08L 23/08; C08F 4/6592; C08F 4/659

(52) U.S. Cl. CPC C08F 110/02; C08L 23/0815; C08F 4/65927; C08F 2410/03; C08L 2207/062; C08L 2314/06; C08F 4/65912

(57) ABSTRACT

The present invention relates to a new process for preparing a polyethylene using new bis(metallocene) compounds in catalyst compositions. The bis(metallocene) compounds of the invention are homo- or hetero bis(metallocene) molecules in which same or different metallocene moieties are connected by a phenylene bridge. The phenylene bridge is either para-substituted, meta-substituted or ortho-substituted by the two metallocene moieties.

### TECHNICAL FIELD OF THE INVENTION

The invention is in the field of polymers technology, and relates to a process for preparing a polyethylene resin. In particular the invention relates to the preparation of bimodal polyethylene resin.

### BACKGROUND OF THE INVENTION

A constant mechanical properties improvement is required in the field of the polymer industry. Such improvement can for example be obtained by tailor made bimodal resins synthesized by metallocene catalysts combined with cascade reactor. The polyethylene resins having bimodal characteristics include resins that comprise two components having different properties, such as for instance two components of different molecular weight, two components of different densities and or two components having different reaction rate with respect to co-monomer.

Bimodal polyethylene resins can be prepared by a physical blending of different monomodal polyethylene product or by sequential polymerization in two separate reactors that are serially interconnected. In such sequential process in cascade reactor, one of the two components of the bimodal blend is produced under a set of conditions in a first reactor and transferred to a second reactor, where under another set of conditions different from those in the first reactor, the second component is produced. Because of the different set of conditions, the second component has properties (such as molecular weight, density, etc.) different from the properties of the first component.

However, the requirement of multiple reactors leads to increase costs for both construction and operation. Moreover, when metallocene-based catalyst systems are used for preparation of the bimodal polyethylene resin in serially connected reactors, the different polymer components obtained may be difficult to mix with one another. If the two components of the bimodal polyethylene are not homogeneously mixed with each other, repeated extrusion may be needed which might lead to a decrease of the mechanical properties of the final product.

To overcome this problem it is possible to use multiple catalysts in a single reactor, each catalyst producing a polyethylene component. Such process is described for instance in WO2006/045738 wherein bimodal polyethylene is produced by combining two different single site catalysts in a single reactor.

Typically, in such a case, multiple separate catalyst injections are performed. For example, the different catalysts are injected separately into the polymerization reactor. Although this process shows high flexibility, several drawbacks must be highlighted: multiple catalysts injections lead to increased costs and polymer homogeneity is difficult to achieve.

Another strategy is the heterogenisation of multiple catalysts on same support which seems to solve those drawbacks. However, this technology suffers from the difficulty to control properly the behavior of metallocene during the heterogenisation process typically leading a dominating structure while the other seems inactive.

Thus, it remains a need in the art to provide an improved method for preparing a bimodal polyethylene resin in a single reactor.

### SUMMARY OF THE INVENTION

The present invention provides such an improved process for preparing ethylene polymers having bimodal or multimodal characteristics in one or more reactor, preferably in one reactor. In accordance with an embodiment of the present invention, a bimodal ethylene polymer is prepared in a single reactor in a process involving the use of a catalyst composition including a bis(metallocene) compound.

The invention relates to a process for preparing a polyethylene resin in one or more reactors, comprising polymerizing ethylene monomer and optionally one or more olefin co-monomer in the presence of a catalyst composition wherein the catalyst composition comprises a bis(metallocene) compound (A) having one of the following formulas:

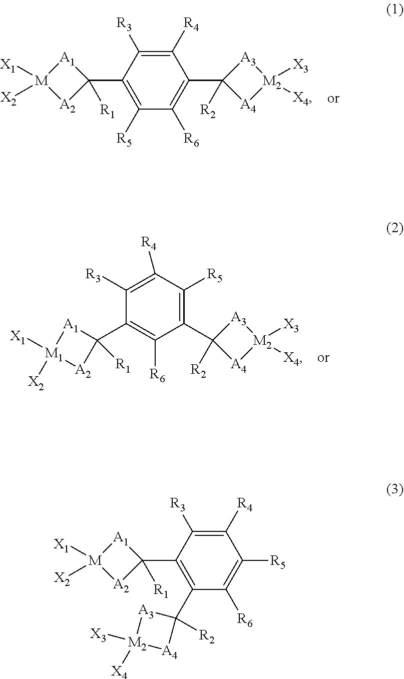

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings, or substituted or unsubstituted fluorenyl rings, or substituted or unsubstituted indenyl rings;
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms;
M1 is Zirconium:
M2 is selected from Zirconium, Hafnium and Titanium;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group

With preference one or more of the following embodiments can be used to define the inventive process:
In the bis(metallocene) compound (A), both M1 and M2 are zirconium or M1 and M2 are different and preferably M2 is hafnium.
In the bis(metallocene) compound (A), A1 and A3 are the same and A2 and A4 are the same so that the bis(metallocene) compound (A) shows a symmetry.
In the bis(metallocene) compound (A), A1 and A3 are the same or different substituted or unsubstituted cyclopentadienyl rings, or substituted or unsubstituted fluorenyl rings, wherein if substituted, the substitutions may be independent and/or linked to form multicyclic structures.
In the bis(metallocene) compound (A), A1 and A3 are the same or different substituted or unsubstituted cyclopentadienyl rings wherein if substituted, the substitutions may be independent and/or linked to form multicyclic structures.
In the bis(metallocene) compound (A), A1 and A3 are the same or different substituted or unsubstituted fluorenyl rings wherein if substituted, the substitutions may be independent and/or linked to form multicyclic structures.
In the bis(metallocene) compound (A), A1 and A3 are the same or different substituted or unsubstituted indenyl rings wherein if substituted, the substitutions may be independent and/or linked to form multicyclic structures.
In the bis(metallocene) compound (A), A2 and A4 are the same or different and selected from substituted or unsubstituted cyclopentadienyl rings, or substituted or unsubstituted fluorenyl rings.
In the bis(metallocene) compound (A), R1 and R2 are independently hydrogen or a methyl group.
In the bis(metallocene) compound (A), R3, R4, R5 and R6 are hydrogen.
In the bis(metallocene) compound (A), at least one of A1, A2, A3 or A4 is a fluorenyl ring.
The bis(metallocene) compound (A) is:

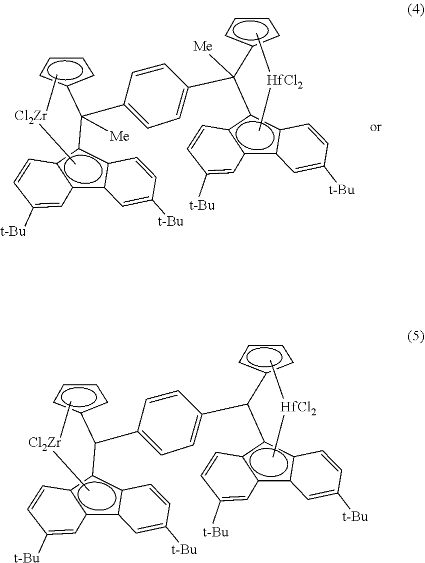

The catalyst composition further comprises a co-catalyst (B).
The co-catalyst (B) is an alumoxane selected from methylalumoxane, modified methyl alumoxane, ethylalumoxane, isobutylalumoxane, or any combination thereof, preferably the co-catalyst (B) is methylalumoxane (MAO).
The co-catalyst is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof, preferably the ionic activator is dimethylanilinium tetrakis(perfluorophenyl)borate.
The co-catalyst (B) is an ionic activator used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL), preferably the co-activator is Tri-Iso-Butyl Aluminum (TIBAL).
The bis(metallocene) compound (A) is or comprises a mixture of a homo bis(metallocene) wherein both M1 and M2 are Zirconium and of a hetero bis(metallocene) wherein M1 and M2 are different and further wherein preferably M2 is Hafnium.
The process is performed in a single reactor, preferably in a single loop reactor.
The process is performed in double loop reactor.
The process is carried out in slurry conditions.
The polyethylene obtained by the process, has a melting temperature Tₘ of at least 110° C. Melting temperatures may be determined according to ISO 3146.
The polyethylene obtained by the process, has a molecular weight distribution (MWD), defined as Mw/Mn, i.e. the ratio of weight average molecular weight (Mw) over number average molecular weight (Mn) of at least 2.5, most preferably of at least 2.7.
The process involves a bis(metallocene) compound (A) wherein both M1 and M2 are zirconium or M1 and M2 are different and preferably M2 is Hafnium, or a bis(metallocene) compound (A) being or comprising a mixture of a homo bis(metallocene) wherein both M1 and M2 are Zirconium and of a hetero bis(metallocene) wherein M1 and M2 are different and further wherein preferably M2 is Hafnium.
The polyethylene resin obtained by the process, is a copolymer of ethylene and hexene.
The polyethylene resin is a high density polyethylene (HDPE) with a density ranging from 0.940 to 0.975 g/cm³, with the density being determined according to ISO 1183.
The polyethylene resin has a bimodal or multimodal molecular weight distribution as evidenced by TREF analysis.

It is noted that other bis(metallocene) compositions than the ones used in accordance with the invention, are already disclosed in prior art such as in WO2010/151315. However, this document does not disclose obtaining bimodal polyolefins in a single reactor.

The invention also encompasses the polyethylene resin as defined above and polyethylene compositions comprising the polyethylene resin as defined above.

The present invention further encompasses articles comprising the polyethylene resin produced according to the present process. Preferred articles are pipes, caps and closures, fibers, films, sheets, containers, rotomoulded articles and injection moulded articles.

### DESCRIPTION OF THE FIGURES

FIGS. 1a and 1b are the mass spectrum of the mixture of homo- and hetero bis(metallocene) compound (5a and 5b) as obtained according to Scheme 8, evidencing the presence of hetero zirconium-hafnium complexes.

FIG. 2 represents a graph plotting a TREF (temperature rising elution fractionation) profile (dW/dT (%/° C.)) as a function of temperature for MDPE resins synthesized with or without the catalyst composition according to the invention.

### DETAILED DESCRIPTION OF THE INVENTION

For the purpose of the invention the following definitions are given:

As used herein, a “polymer” is a polymeric compound prepared by polymerising monomers, whether of the same or a different type. The generic term polymer thus embraces the term homopolymer, usually employed to refer to polymers prepared from only one type of monomer, and the terms copolymer and interpolymer as defined below.

As used herein, a “copolymer”, “interpolymer” and like terms mean a polymer prepared by the polymerisation of at least two different types of monomers. These generic terms include polymers prepared from two or more different types of monomers, i.e. terpolymers, tetrapolymers, etc.

For the purpose of the invention, the terms “polyethylene” (PE) and “ethylene polymer” may be used synonymously. The term “metallocene polyethylene” is used to denote a polyethylene produced with a metallocene catalyst. The produced “metallocene polyethylene” may be labeled as “mPE”. A metallocene ethylene copolymer can be derived from ethylene and a comonomer such as one or more selected from the group consisting of C₃-C₁₀ alpha-olefins, such as 1-butene, 1-propylene, 1-pentene, 1-hexene, 1-octene.

The term “polyethylene” or “polyethylene resin” as used herein refers to the polyethylene fluff or powder that is extruded, and/or melted and/or pelletized, for instance with mixing and/or extruder equipment. The term “fluff” or “powder” as used herein refers to the polyethylene material with the hard catalyst particle at the core of each grain and is defined as the polymer material after it exits the polymerization reactor (or final polymerization reactor in the case of multiple reactors connected in series).

“Bimodal polyethylene” as used herein refers to a bimodal polyethylene resin comprising two components having different properties, such as for instance two components of different molecular weight, two components of different densities, and/or two components having different productivities or reaction rate with respect to co-monomer. In an example, one of said fractions has higher molecular weight than said other fraction.

“Multimodal polyethylene” as used herein refers to a multimodal polyethylene resin comprising two or more components having different properties, such as for instance two or more components of different molecular weight, two or more component components of different densities, and/or two or more components having different productivities or reaction rate with respect to co-monomer. In accordance with an embodiment of the invention, multimodal polyethylene comprising more than two components having different properties may be obtained in two reactors connected in series and operated under different set of conditions.

The term “co-catalyst” is used generally herein to refer to organoaluminum compounds that can constitute one component of a catalyst composition. Additionally, “co-catalyst” refers to other component of a catalyst composition including, but not limited to, aluminoxanes, organoboron or organoborate compounds and ionizing ionic compound (i.e. ionic activator). The term “co-catalyst” is used regardless of the actual function of the compound or any mechanical mechanism by which the compound may operate. In one aspect of this invention the term “co-catalyst” is used to distinguish that component of the catalyst composition from the bis(metallocene) compound.

The term “bis(metallocene)”, as used herein, describes a compound comprising two metallocene moieties linked by a phenylene group.

Unless otherwise specified the following abbreviations may be used Cp for cyclopentadienyl, Ind for indenyl, and Flu for fluorenyl.

For any particular compound disclosed herein, any general or presented structure presented also encompasses all conformational isomers, regioisomers, and stereoisomers that may arise from a particular set of substituents. The general or specific structure also encompasses all enantiomers, diastereomers, and other optical isomers whether in enantiomeric or racemic forms, as well as mixtures of stereoisomers, as would be recognized by a person skilled in the art.

The terms “comprising”, “comprises” and “comprised of” as used herein are synonymous with “including”, “includes” or “containing”, “contains”, and are inclusive or open-ended and do not exclude additional, non-recited members, elements or method steps. The terms “comprising”, “comprises” and “comprised of” also include the term “consisting of”.

The recitation of numerical ranges by endpoints includes all numbers and fractions subsumed within the respective ranges, as well as the recited endpoints.

The particular features, structures, characteristics or embodiments may be combined in any suitable manner, as would be apparent to a person skilled in the art from this disclosure, in one or more embodiments.

The present invention is directed to a process preparing a polyethylene resin in one or more reactors using new catalyst compositions comprising new bis(metallocene) compounds. In particular, the invention is directed to a process for preparing bimodal or multimodal polyethylene resin in one or more reactors, preferably in a single reactor.

The bis(metallocene) of the invention are homo- or heterodinuclear molecules in which same or different metallocene moieties are connected by a phenylene bridge. The phenylene bridge is para-substituted, meta-substituted or ortho-substituted by the two metallocene moieties.

The present invention relates to a process for preparing a polyethylene resin in one or more reactors, comprising polymerizing ethylene monomer and optionally one or more olefin co-monomer in the presence of a catalyst composition wherein the catalyst composition comprises a bis(metallocene) compound (A) having one of the following formulas:

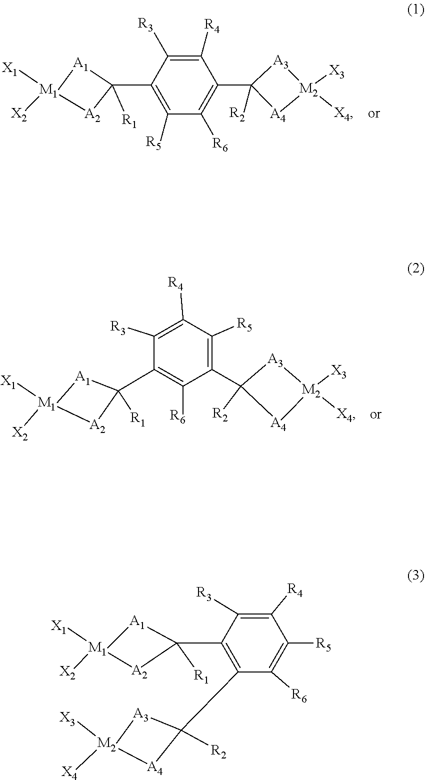

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings, or substituted or unsubstituted fluorenyl rings, or substituted or unsubstituted indenyl rings;
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms;
M1 is Zirconium;
M2 is selected from Zirconium, Hafnium and Titanium;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group.

In these formulas halogen includes fluorine (F), chlorine (Cl), bromine (Br), and iodine (1) atoms.

As used herein, an aliphatic group includes linear or branched alkyl and alkenyl groups. Generally, the aliphatic group contains from 1 to 20 carbon atoms. Unless otherwise specified, alkyl and alkenyl groups described herein are intended to include all structural isomers, linear or branched, of a given moiety; for example, all enantiomers and all diastereomers are included within this definition. As an example, unless otherwise specified, the term propyl is meant to include n-propyl and iso-propyl, while the term butyl is meant to include n-butyl, iso-butyl, t-butyl, sec-butyl, and so forth.

Suitable examples of alkyl groups which can be employed in the present invention include, but are not limited to, methyl, ethyl, propyl, butyl, pentyl, hexyl, heptyl, octyl, nonyl, or decyl, and the like. Examples of alkenyl groups within the scope of the present invention include, but are not limited to, ethenyl, propenyl, butenyl, pentenyl, hexenyl, heptenyl, octenyl, nonenyl, decenyl, and the like.

Aromatic groups and combinations with aliphatic groups include aryl and arylalkyl groups, and these include, but are not limited to, phenyl, alkyl-substituted phenyl, naphthyl, alkyl-substituted naphthyl, phenyl-substituted alkyl, naphthyl-substituted alkyl, and the like. Generally, such groups and combinations of groups contain less than about 20 carbon atoms. Hence, non-limiting examples of such moieties that can be used in the present invention include phenyl, tolyl, benzyl, dimethylphenyl, trimethylphenyl, phenylethyl, phenylpropyl, phenylbutyl, propyl-2-phenylethyl, and the like.

Cyclic groups include cycloalkyl and cycloalkenyl moieties and such moieties can include, but are not limited to, cyclopentyl, cyclopentenyl, cyclohexyl, cyclohexenyl, and the like. One example of a combination including a cyclic group is a cyclohexylphenyl group.

Unless otherwise specified, any substituted aromatic or cyclic moiety used herein is meant to include all regioisomers; for example, the term tolyl is meant to include any possible substituent position, i.e. ortho, meta, or para.

Hydrocarbyl is used herein to specify a hydrocarbon radical group that includes, but is not limited to, aryl, alkyl, cycloalkyl, alkenyl, cycloalkenyl, cycloalkadienyl, alkynyl, aralkyl, aralkenyl, aralkynyl, and the like, and includes all substituted, unsubstituted, branched, linear, and/or heteroatom substituted derivatives thereof. Unless otherwise specified, the hydrocarbyl groups of this invention typically comprise up to about 20 carbon atoms. In another aspect, hydrocarbyl groups can have up to 12 carbon atoms, for instance, up to 8 carbon atoms, or up to 6 carbon atoms.

Alkoxide and aryloxide groups both can comprise up to about 20 carbon atoms. Illustrative and non-limiting examples of alkoxide and aryloxide groups include methoxy, ethoxy, propoxy, butoxy, phenoxy, substituted phenoxy, and the like.

Silylcarbyl groups are groups in which the silyl functionality is bonded directly to the indicated atom or atoms. Examples include SiH₃, SiH₂R*, SiHR*₂, SiR*₃, SiH₂(OR*), SiH(OR*)₂, Si(OR*)₃, SiH₂(NR*₂), SiH(NR*₂)₂, Si(NR*₂)₃, and the like where R* is independently a hydrocarbyl or halocarbyl radical and two or more R* may join together to form a substituted or unsubstituted saturated, partially unsaturated or aromatic cyclic or polycyclic ring structure.

Germylcarbyl groups are groups in which the germyl functionality is bonded directly to the indicated atom or atoms. Examples include GeH₃, GeH₂R*, GeHR*₂, GeR*₃, GeH₂(OR*), GeH(OR*)₂, Ge(OR*)₃, GeH₂(NR*₂), GeH(NR*₂)₂, Ge(NR*₂)₃, and the like where R* is independently a hydrocarbyl or halocarbyl radical and two or more R* may join together to form a substituted or unsubstituted saturated, partially unsaturated or aromatic cyclic or polycyclic ring structure.

In a preferred embodiment, A1 and A3 are the same and A2 and A4 are the same so that the bis(metallocene) compound (A) shows a symmetry.

In another preferred embodiment R1 and R2 are independently hydrogen or a methyl group, and/or R3, R4, R5 and R6 are hydrogen, and/or, at least one of A1, A2, A3 or A4 is a fluorenyl ring.

The bis(metallocene) compound of the invention may be hetero bis(metallocene) compound because each metallocene moiety linked by the phenylene bridge is the different and/or contain a different metal center. Non-limiting examples of hetero bis(metallocene) compounds in accordance with the invention have the following formulas:

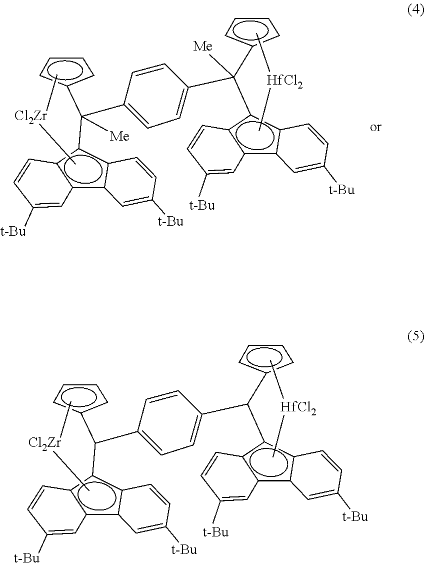

The bis(metallocene) compound of the invention may be homo bis(metallocene) compound because each metallocene moiety linked by the phenylene bridge is the same and contain the same metal center. Non-limiting examples of homo bis(metallocene) compounds in accordance with the invention have the following formulas:

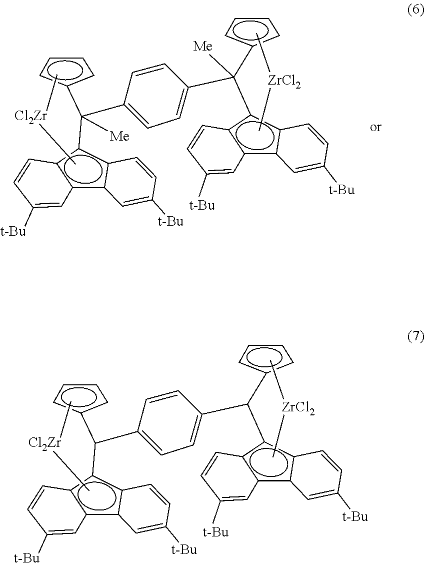

Methods of making bis(metallocene) compounds of the present invention are also provided. Bis(metallocene) compounds were obtained using a standard salt metathesis reaction between two equivalents of the metal precursors and ligand tetra anions.

The metal precursor is a mixture of zirconium tetrachloride (ZrCl₄) with one selected from zirconium tetrachloride (ZrCl₄), hafnium tetrachloride (HfCl₄), titanium tetrachloride (TiCl₄), zirconium tetrachloride complex 1:2 with tetrahydrofuran (ZrCl₄.2THF); hafnium tetrachloride complex 1:2 with tetrahydrofuran (HfCl₄.2THF) and titanium tetrachloride complex 1:2 with tetrahydrofuran (TiCl₄.2THF).

The proligand has one of the following formulas:

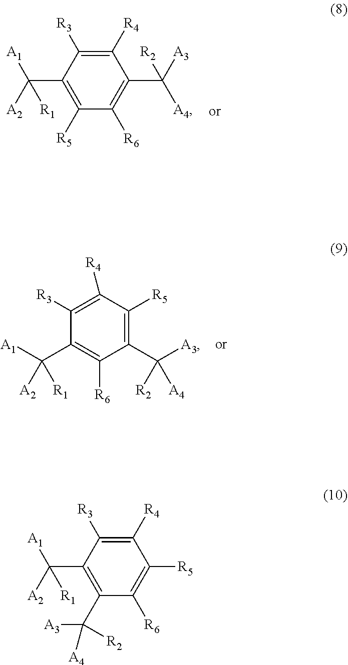

wherein
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures;
A2 and A4 are the same or different and selected from substituted or unsubstituted cyclopentadienyl rings, or substituted or unsubstituted fluorenyl rings, or substituted or unsubstituted indenyl rings;
R1 and R2 are independently hydrogen or a substituted or unsubstituted aliphatic, aromatic, or cyclic group;
R3, R4, R5 and R6 are independently hydrogen or a substituted or unsubstituted aliphatic, aromatic, or cyclic group.
For example the proligand is a bis (Cp/flu) proligand of the following formula

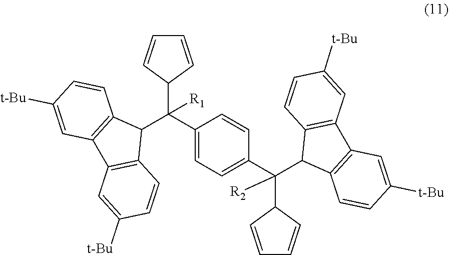

wherein R1 and R2 are independently hydrogen or a substituted or unsubstituted aliphatic, aromatic, or cyclic group

Synthesis process of such proligand is well known to the person skilled in the art and is described for example in U.S. Pat. Nos. 2,512,698 and 2,587,791, which are included herein by reference. With preference, in the invention, pyrolidine is used as catalyst of the reaction.

The catalyst composition according to the invention preferably comprises a bis(metallocene) compound (A) as defined above and a co-catalyst (B).

In a preferred embodiment the co-catalyst (B) is an alumoxane selected from methylalumoxane, modified methyl alumoxane, ethylalumoxane, isobutylalumoxane, or any combination thereof, preferably the co-catalyst (B) is methylalumoxane (MAO).

In another preferred embodiment, the co-catalyst (B) is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof, preferably the ionic activator is dimethylanilinium tetrakis(perfluorophenyl)borate. In such a case the co-catalyst (B) is preferably used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL), preferably the co-activator is Tri-Iso-Butyl Aluminum (TIBAL).

In a preferred embodiment, the bis(metallocene) compound (A) comprises a mixture of a homo bis(metallocene) wherein both M1 and M2 are zirconium and of a hetero bis(metallocene) wherein M1 and M2 are different and further wherein preferably M2 is hafnium. Preferably, in such a case, the proligand used to produce the dinuclear compound is the same in the homo bis(metallocene) and in the hetero bis(metallocene). The mixture of homo- and hetero bis(metallocene) compound is obtained by reaction of metal precursors and a tetra anion ligand.

The metallocene may be supported according to any method known in the art. In the event it is supported, the support used in the present invention can be any organic or inorganic solid, particularly porous support such as silica, talc, inorganic oxides, and resinous support material such as polyolefin. Preferably, the support material is an inorganic oxide in its finely divided form.

The polymerisation of ethylene and one or more optional comonomers in the presence of a bis(metallocene) catalyst composition can be carried out according to known techniques in one or more polymerisation reactors. With preference, the polymerisation of ethylene and one or more optional comonomers in presence of bis(metallocene) catalyst composition according to the invention is carried out in a single polymerisation reactor.

The polyethylene of the present invention is preferably produced by polymerisation in an “isobutane-ethylene-supported catalyst” slurry at temperatures in the range from 20° C. to 110° C., preferably in the range from 60° C. to 110° C. The pressure can be atmospheric or higher, preferably between 20 and 50 bar. The molecular weight of the polymer chains, and in consequence the melt flow of the metallocene polyethylene is mainly regulated by the addition of hydrogen in the polymerisation medium. The density of the polymer chains is regulated by the addition of one or more comonomers in the polymerisation medium.

Preferably, the polyethylene resin obtained by the invention has a melting temperature Tₘ of at least 110° C. Melting temperatures may be determined according to ISO 3146.

The polyethylene resin has a melt flow index (MFI) ranging from 0.1 to 1000 g/10 min, preferably 0.1 to 500 g/10 min. Preferably, the polyethylene has a melt flow index (MFI) of at most 200 g/10 min.

Preferably, the polyethylene resin of the invention has a molecular weight distribution (MWD), defined as Mw/Mn, i.e. the ratio of weight average molecular weight (Mw) over number average molecular weight (Mn) of at least 2.5, most preferably of at least 2.7. Preferably the polyethylene of the invention has a molecular weight distribution of at most 10, preferably of at most 6

Preferably, the polyethylene resin produced with the inventive process is selected from the group comprising low density polyethylene, medium and high density polyethylene. In an embodiment, the polyethylene has a density of 0.890 to 0.975 g/cm³, preferably of from 0.890 to 0.960 g/cm³ with the density being determined according to ISO 1183. Preferably, the polyethylene is high density polyethylene (HDPE). Suitable high density polyethylene (HDPE) has a density ranging from 0.940 to 0.975 g/cm³, with the density being determined according to ISO 1183.

The polyethylene resin is a homopolymer, a copolymer of ethylene and at least one comonomer, or a mixture thereof.

In an embodiment of the invention, the polyethylene is a homopolymer. The term homopolymer refers to a polymer which is made in the absence of comonomer or with less than 0.2 wt %, more preferably less than 0.1 wt %, most preferably less than 0.05 wt % of comonomer.

In an embodiment of the invention, the polyethylene is a copolymer of ethylene and at least one comonomer.

Suitable comonomers comprise but are not limited to aliphatic C₃-C₂₀ alpha-olefins. Examples of suitable aliphatic C₃-C₂₀ alpha-olefins include propylene, 1-butene, 1-pentene, 4-methyl-1-pentene, 1-hexene, 1-octene, 1-decene, 1-dodecene, 1-tetradecene, 1-hexadecene, 1-octadecene and 1-eicosene. Preferably, the comonomer is 1-hexene.

In case the polyethylene is a copolymer, it comprises at least 0.1 wt % of comonomer, preferably at least 1 wt %. The ethylene copolymer comprises up to 10 wt % of comonomer and most preferably up to 6 wt %.

The invention also encompasses polyethylene compositions comprising the polyethylene as defined above.

In an embodiment, the polyethylene composition of the invention may also comprise further additives, such as by way of example, antioxidants, light stabilizers, acid scavengers, lubricants, antistatic additives, nucleating agents and colorants. An overview of such additives may be found in Plastics Additives Handbook, ed. H. Zweifel, 5^{th} edition, 2001, Hanser Publishers. The total content of these additives does generally not exceed 10 parts, preferably not 5 parts, by weight per 100 parts by weight of the final product.

Polymerisation can be carried out in gas phase or slurry conditions. In an embodiment, ethylene polymerizes in a liquid diluent in the presence of a polymerisation catalyst composition as defined herein, optionally a co-monomer, optionally hydrogen and optionally other additives, thereby producing polymerization slurry comprising bimodal polyethylene.

As used herein, the term “polymerization slurry” or “polymer slurry” or “slurry” means substantially a multi-phase composition including at least polymer solids and a liquid phase, the liquid phase being the continuous phase. The solids include catalyst and a polymerized olefin, in the present case bimodal polyethylene. The liquids include an inert diluent, such as isobutane, dissolved monomer such as ethylene, co-monomer, molecular weight control agents, such as hydrogen, antistatic agents, antifouling agents, scavengers, and other process additives.

Suitable diluents are well known in the art and include but are not limited to hydrocarbon diluents such as aliphatic, cycloaliphatic and aromatic hydrocarbon solvents, or halogenated versions of such solvents. The preferred solvents are C₁₂ or lower, straight chain or branched chain, saturated hydrocarbons, C₅-C₉ saturated alicyclic or aromatic hydrocarbons or C₂-C₆ halogenated hydrocarbons. Non-limiting illustrative examples of solvents are butane, isobutane, pentane, hexane, heptane, cyclopentane, cyclohexane, cycloheptane, methyl cyclopentane, methyl cyclohexane, isooctane, benzene, toluene, xylene, chloroform, chlorobenzenes, tetrachloroethylene, dichloroethane and trichloroethane. In a preferred embodiment of the present invention, said diluent is isobutane. However, it should be clear from the present invention that other diluents may as well be applied according to the present invention.

The person skilled in the art will appreciate that the nature, amounts and concentrations of the above given monomers, co-monomers, polymerisation catalyst, and additional compounds for the polymerization as well as the polymerization time and reaction conditions in the reactor can vary depending on the desired bimodal polyethylene product.

In an embodiment, the process is carried out in a loop reactor, for instance in a single or in a double loop reactor wherein a double loop reactor comprises two loop reactor connected in series. Preferably the process is carried out in a single loop reactor.

The present invention also encompasses articles comprising the polyethylene resin produced according to the present process. Preferred articles are pipes, caps and closures, fibers, films, sheets, containers, foams, artificial grass, rotomoulded articles and injection moulded articles.

The present inventors have found that polyethylene resin produced according to the invention have an improved homogeneity. The process provides thus advantages such as ease of processing.

### Test Methods

The melt flow index (MFI) of the polyethylene or polyethylene composition is determined according to ISO 1133 at 190° C. under a load of 2.16 kg.

Density of polyethylene is determined according to ISO 1183.

Molecular weights are determined by Size Exclusion Chromatography (SEC) at high temperature (145° C.). A 10 mg polyethylene sample is dissolved at 160° C. in 10 mL of trichlorobenzene (technical grade) for 1 hour. Analytical conditions for the GPC_IR from Polymer Char are:
Injection volume: +/−400 μL;
Automatic sample preparation and injector temperature: 160° C.;
Column temperature: 145° C.;
Detector temperature: 160° C.;
Column set: 2 Shodex AT-806MS and 1 Styragel HT6E;
Flow rate: 1 mL/min;
Detector: IR5 Infrared detector (2800-3000 cm⁻¹);
Calibration: Narrow standards of polystyrene (commercially available);
Calculation for polypropylene: Based on Mark-Houwink relation (log₁₀(M_{PP})=log₁₀(M_{PS})−0.25323); cut off on the low molecular weight end at M_{PP}=1000;
Calculation for polyethylene: Based on Mark-Houwink relation (log₁₀(M_{PE})=0.965909×log₁₀(M_{PS})−0.28264); cut off on the low molecular weight end at M_{PE}=1000.

The molecular weight averages used in establishing molecular weight/property relationships are the number average (Mₙ), weight average (M_{w}) and z average (M_{z}) molecular weight. These averages are defined by the following expressions and are determined form the calculated Mᵢ:

$${M}_{n} = \frac{{\sum }_{i} {N}_{i} {M}_{i}}{{\sum }_{i} {N}_{i}} = \frac{{\sum }_{i} {W}_{i}}{{\sum }_{i} {W}_{i} / {M}_{i}} = \frac{{\sum }_{i} {h}_{i}}{{\sum }_{i} {h}_{i} / {M}_{i}}$$

$${M}_{w} = \frac{{\sum }_{i} {N}_{i} {M}_{i}^{2}}{{\sum }_{i} {N}_{i} {M}_{i}} = \frac{{\sum }_{i} {W}_{i} {M}_{i}}{{\sum }_{i} {M}_{i}} = \frac{{\sum }_{i} {h}_{i} {M}_{i}}{{\sum }_{i} {M}_{i}}$$

$${M}_{z} = \frac{{\sum }_{i} {N}_{i} {M}_{i}^{3}}{{\sum }_{i} {N}_{i} {M}_{i}^{2}} = \frac{{\sum }_{i} {W}_{i} {M}_{i}^{2}}{{\sum }_{i} {W}_{i} {M}_{i}} = \frac{{\sum }_{i} {h}_{i} {M}_{i}^{2}}{{\sum }_{i} {h}_{i} {M}_{i}}$$

Here Nᵢ and Wᵢ are the number and weight, respectively, of molecules having molecular weight Mᵢ. The third representation in each case (farthest right) defines how one obtains these averages from SEC chromatograms. hᵢ is the height (from baseline) of the SEC curve at the iₜₕ elution fraction and Mᵢ is the molecular weight of species eluting at this increment.

The molecular weight distribution (MWD or D) is then calculated as Mw/Mn.

The ¹³C-NMR analysis is performed using a 400 MHz or 500 MHz Bruker NMR spectrometer under conditions such that the signal intensity in the spectrum is directly proportional to the total number of contributing carbon atoms in the sample. Such conditions are well known to the skilled person and include for example sufficient relaxation time etc. In practice the intensity of a signal is obtained from its integral, i.e. the corresponding area. The data is acquired using proton decoupling, 2000 to 4000 scans per spectrum with 10 mm room temperature through or 240 scans per spectrum with a 10 mm cryoprobe, a pulse repetition delay of 11 seconds and a spectral width of 25000 Hz (+/−3000 Hz). The sample is prepared by dissolving a sufficient amount of polymer in 1,2,4-trichlorobenzene (TCB, 99%, spectroscopic grade) at 130° C. and occasional agitation to homogenise the sample, followed by the addition of hexadeuterobenzene (CD₆, spectroscopic grade) and a minor amount of hexamethyldisiloxane (HMDS, 99.5+%), with HMDS serving as internal standard. To give an example, about 200 mg to 600 mg of polymer are dissolved in 2.0 mL of TCB, followed by addition of 0.5 mL of CD₆ and 2 to 3 drops of HMDS.

Following data acquisition the chemical shifts are referenced to the signal of the internal standard HMDS, which is assigned a value of 2.03 ppm.

The comonomer content of a polyethylene is determined by ¹³C-NMR analysis of pellets according to the method described by G. J. Ray et al. in Macromolecules, vol. 10, no 4, 1977, p. 773-778.

Melting temperatures Tₘ were determined according to ISO 3146 on a DSC Q2000 instrument by TA Instruments.

Temperature Rising Elution Fractionation analysis (TREF analysis) was performed using the method similar to as described in Soares and Hamielec, Polymer, 36 (10), 1995 1639-1654, incorporated herein in its entirety by reference. The TREF analysis was performed on a TREF model 200 series instrument equipped with Infrared detector from Polymer Char. The samples were dissolved in 1,2-dichlorobenzene at 150° C. for 1 h. The following parameters as shown in Table 1 were used.

TABLE 1

| METHOD INFORMATION | |
|---|---|
| Dissolution Rate (° C./min) | 40 |
| Stabilization Rate (° C./min) | 40 |
| Crystallization Rate 1 (° C./min) | 0.5 |
| Elution Rate (° C./min) | 1 |
| Cleaning rate (° C./min) | 30 |
| Dissolution temperature (° C.) | 150 |
| Stabilization temperature (° C.) | 95 |
| Crystallization temperature (° C.) | 35 |
| Elution init temp (° C.) | 35 |
| Elution temperature (° C.) | 140 |
| Post elution temperature (° C.) | 150 |
| Cleaning temperature (° C.) | 150 |
| Dissolution time (min) | 60 |
| Stabilization time (min) | 45 |
| Crystallization time (min) | 10 |
| Pre-injection time (min) | 10 |
| Soluble Fraction time (min) | 10 |
| post elution time (min) | 10 |
| High rpm | 200 |
| Low rpm | 100 |
| T on (s) | 5 |
| T off (s) | 120 |
| Dissolution stirring | High |
| Stabilization stirring | High |
| Filling vessels volume (mL) | 20 |
| Filling vessels pick up speed (mL/min) | 40 |
| Filling vessels pump speed (mL/min) | 15 |
| Analysis discarded sample volume (mL) | 2 |
| Analysis discarded waste volume (mL) | 6 |
| Analysis sample volume (mL) | 0.3 |
| Column load volume (mL) | 1.9 |
| Analysis waste volume (mL) | 5 |
| Analysis returned volume (mL) | 1 |
| Analysis pick up rate (mL/min) | 8 |
| Analysis dispensing rate (mL/min) | 3 |
| Cleaning volume (mL) | 30 |
| Cleaning pick up speed (mL/min) | 40 |
| Cleaning pump speed (mL/min) | 15 |
| Top oven temperature (° C.) | 140 |
| Pump Flow (mL/min) | 0.5 |

Mass spectrometry: Samples were analyzed using APPI (Atmospheric Pressure Photolonization): lampe UV (Krypton, 10.6 eV) coupled with IMS-MS (Ion Mobility Spectrometry-Mass Spectrometry) detector using the method known in the art.

The following non-limiting examples illustrate the invention.

### EXAMPLES

The present invention will be further described with reference to the following examples, but it should be construed that the invention is in no way limited to those examples.

### Example 1: Synthesis of the Proligands

The fluorenyl-cyclopentadienyl type proligands (Cp/Flu proligands) of the catalysts have been synthetized by nucleophilic additions of fluorenyl anions to fulvenes (i.e. the “fulvene method”). By comparison to the patent literature, the procedure used the sodium methanolate was replaced by pyrolidine as catalyst of the reaction. The synthesis of para-substituted dilfulvenes (1a-b) was obtained according to reaction scheme 1:

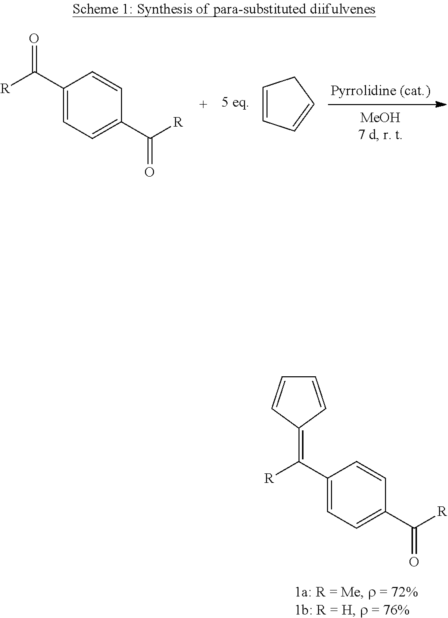

1,4-Bis(1-(cyclopenta-2,4-dien-1-ylidene)ethyl)benzene (1a): In a 250 mL round bottom flask equipped with a magnetic stirring bar and a nitrogen inlet freshly cracked cyclopentadiene (12.36 mL, 148 mmol) and 1,4-diacetylbenzene (4.82 g, 30 mmol) were dissolved in methanol (200 mL). To this solution pyrrolidine (7.5 mL, 89 mmol) was added at 0° C. The reaction mixture was stirred at room temperature for 7 days. After neutralization with glacial acetic acid (7.5 mL) and separation of the organic phase, volatiles were evaporated under vacuum to give a yellow powder (5.51 g, 21.3 mmol, 72%).

1,4-Bis(cyclopenta-2,4-dien-1-ylidenemethyl)benzene (1b): Using a protocol similar to that described above for 1,4-bis(1-(cyclopenta-2,4-dien-1-ylidene)ethyl)benzene, 1,4-bis(cyclopenta-2,4-dien-1-ylidenemethyl)benzene was prepared from cyclopentadiene (30.7 mL, 373 mmol), 1,3-terephthalaldehyde (10.0 g, 74.5 mmol) and pyrrolidine (9.3 mL, 112 mmol) and isolated as an orange powder (13.03 g, 56.7 mmol, 76%).

The synthesis of meta-substituted difulvenes (1c-d) was obtained according to reaction scheme 2:

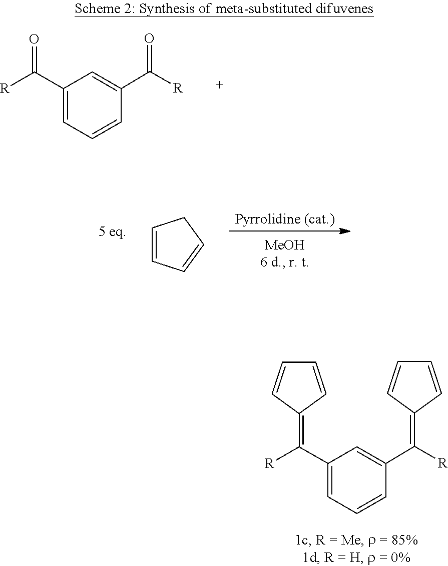

1,3-Bis(1-(cyclopenta-2,4-dien-1-ylidene)ethyl)benzene (1c): Using a protocol similar to that described above for 1,4-bis(1-(cyclopenta-2,4-dien-1-ylidene)ethyl)benzene, 1,3-bis(1-(cyclopenta-2,4-dien-1-ylidene)ethyl)benzene was prepared from cyclopentadiene (30.0 mL, 363 mmol), 1,3-diacetylbenzene (11.0 g, 68 mmol) and pyrrolidine (17.0 mL, 204 mmol) and isolated as an orange powder (14.9 g, 51 mmol, 85%).

Compounds 1a-c were obtained in very good yields but the corresponding meta-substituted difulvene 1d could not be obtained using this procedure, or Thiele's procedure (using methalonate instead of pyrrolidine) or even by using sodium cyclopentadienyl as reactant Then, to prepare the target bis{fluorenyl-cyclopentadienyl} type proligands (2a-c), these difulvenes were subsequently reacted with two equivalents of [3,6-^{t}Bu₂Flu]⁻ Li⁺ as described in reaction scheme 3 starting from the para-substituted dilfulvenes and in reaction scheme 4 starting from the meta-substituted dilfulvenes:

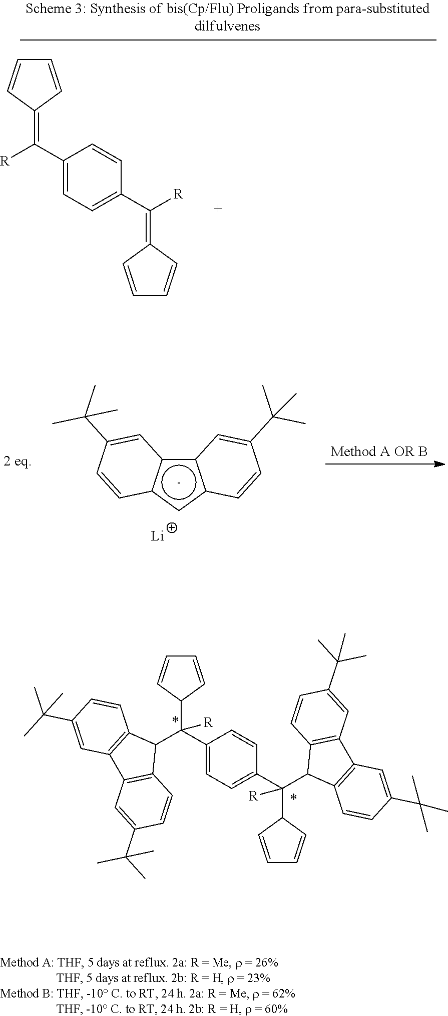

Two methods were investigated to form these proligands and the yields could be improved by carrying out the addition of fluorenyllithium solution to the difulvene solution at −10° C. (Method B).

### 1,4-Bis(1-(cyclopentadienyl)-1-(3,6-di-tert-butyl-fluorenyl)ethyl)benzene (2a)

Method A: In a Schlenk flask, to a solution of 3,6-di-tert-butyl-fluorene (2.17 g, 7.8 mmol) in THF (100 mL) was added n-butyllithium (3.13 mL of a 2.5 M solution in hexane, 7.8 mmol). This solution was added dropwise to a solution of 1,3-bis(1-(cyclopenta-2,4-dien-1-ylidene)ethyl)benzene (1.00 g, 3.9 mmol) in THF (100 mL) at room temperature over 10 minutes. The reaction mixture was stirred for 5 days under reflux. The mixture was hydrolyzed with 10% aqueous hydrochloric acid (20 mL), the organic phase was dried over sodium sulfate, and the solvent was evaporated in vacuo. The resulting solid was washed with pentane (200 mL) and dried to obtain a white powder (731 mg, 0.91 mmol, 26%).

Method B: The procedure is similar to the previous Method A, except that addition of the fluorenyllithium solution was carried out at −10° C. over 10 min. After completion of the addition, the reaction mixture was stirred for 24 h at room temperature. Identical work-up afforded the title compound as a white powder (1.96 g, 2.4 mmol, 62%).

### 1,4-Bis(1-(cyclopentadienyl)-1-(3,6-di-tert-butyl-fluorenyl)methyl)benzene (2b)

Method A: Using a protocol similar to that described above for 1,4-bis(1-(cyclopentadienyl)-1-(3,6-di-tert-butyl-fluorenyl)ethyl)benzene, the title compound was prepared from 3,6-di-tert-butyl-fluorene (4.83 g, 17.4 mmol), n-butyllithium (7.0 mL of a 2.5 M solution in hexane, 17.4 mmol), 1,4-bis(cyclopenta-2,4-dien-1-ylidenemethyl)benzene (2.00 g, 8.7 mmol) and isolated as a white powder (1.66 g, 2.1 mmol, 23%).

Method B: Using a protocol similar to that described above for 1,4-bis(1-(cyclopentadienyl)-1-(3,6-di-tert-butyl-fluorenyl)ethyl)benzene, the title compound was prepared from 3,6-di-tert-butyl-fluorene (4.83 g, 17.4 mmol), n-butyllithium (7.0 mL of a 2.5 M solution in hexane, 17.4 mmol), 1,4-bis(cyclopenta-2,4-dien-1-ylidenemethyl)benzene (2.00 g, 8.7 mmol) and isolated as a white powder

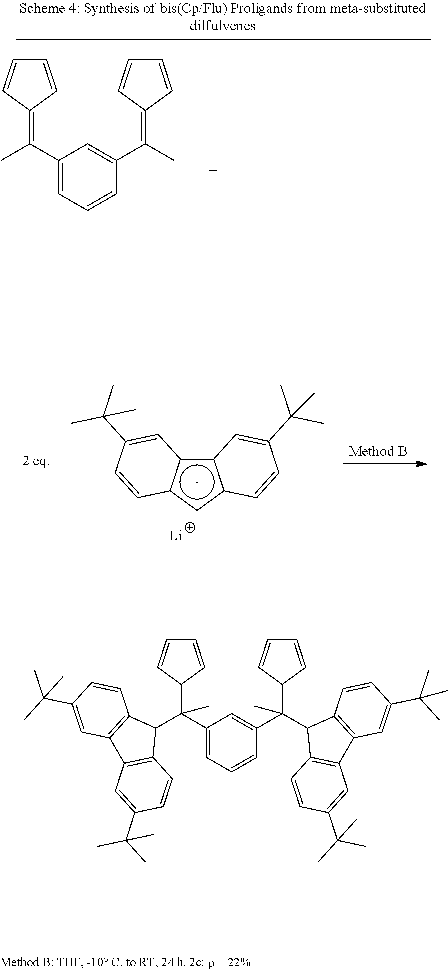

### 1,3-Bis(1-(cyclopentadienyl)-1-(3,6-di-tert-butyl-fluorenyl)ethyl)benzene (2c)

Method B: In a Schlenk flask, to a solution of 3,6-di-tert-butyl-fluorene (2.17 g, 7.8 mmol) in THF (50 mL) was added n-butyllithium (3.13 mL of a 2.5 M solution in hexane, 7.8 mmol). This solution was added dropwise to a solution of 1,3-bis(1-(cyclopenta-2,4-dien-1-ylidene)ethyl)benzene (1.00 g, 3.9 mmol) at −10° C. over 10 min. After completion of the addition, the reaction mixture was stirred for 24 h at room temperature. The mixture was hydrolyzed with 10% aqueous hydrochloric acid (20 mL), the organic phase was separated and dried over sodium sulfate, and the solvent was evaporated in vacuo. The resulting solid was washed with pentane (100 mL) and dried to leave a white powder (469 mg, 0.58 mmol, 22%).

### Example 2: Synthesis of Homo Bis(Metallocene)s

Bis(metallocene) zirconium complexes were obtained using a standard salt metathesis reaction between 2 equivalents of the corresponding tetrachloride precursors (ZrCl₄) and ligand tetra anions, prepared in situ via addition of four equivalents of n-butyllithium in Et₂O, in accordance with reaction schemes 5 and 6.

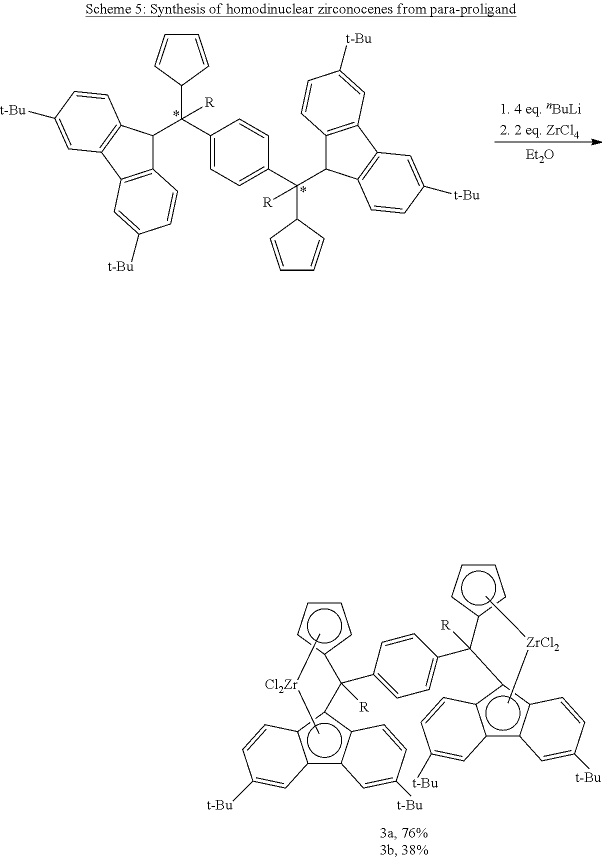

### 1,4-Benzenebis{(cyclopenta-2,4-dien-1-yl(3,6-di-tert-butyl-fluoren-9-yl)ethyl)zirconiumdichloride} (3a)

To a solution of 1,4-bis(cyclopenta-2,4-dien-1-yl(3,6-di-tert-butyl-fluoren-9-yl)ethyl)benzene (0.50 g 0.61 mmol) in diethyl ether (50 mL) was added under stirring n-butyllithium (0.98 mL of a 2.0 M solution in hexane, 2.45 mmol, 4 equiv.). The solution was kept overnight at room temperature. Then ZrCl₄ (0.286 g, 1.23 mmol, 2 equiv.) was added with a bent finger. The resulting red mixture was stirred at room temperature overnight. Then, the mixture was evaporated under vacuum, CH₂Cl₂ (20 mL) was added, the resulting solution was filtered and the solvent was evaporated in vacuo to give a red powder (0.528 g, 0.46 mmol, 76%).

### 1,4-Benzenebis{(cyclopenta-2,4-dien-1-yl(3,6-di-tert-butyl-fluoren-9-yl)methyl)zirconiumdichloride} (3b)

This compound was prepared as described above for 3a, starting from 1,4-bis(cyclopenta-2,4-dien-1-yl(3,6-di-tert-butyl-fluoren-9-yl)methyl)benzene (0.66 g, 0.84 mmol), n-butyllithium (1.37 mL of a 2.0 M solution in hexane, 3.37 mmol, 4 equiv.) and ZrCl₄ (0.392 g, 1.68 mmol, 2 equiv.). The compound was isolated as a red powder (0.350 g, 0.32 mmol, 38%).

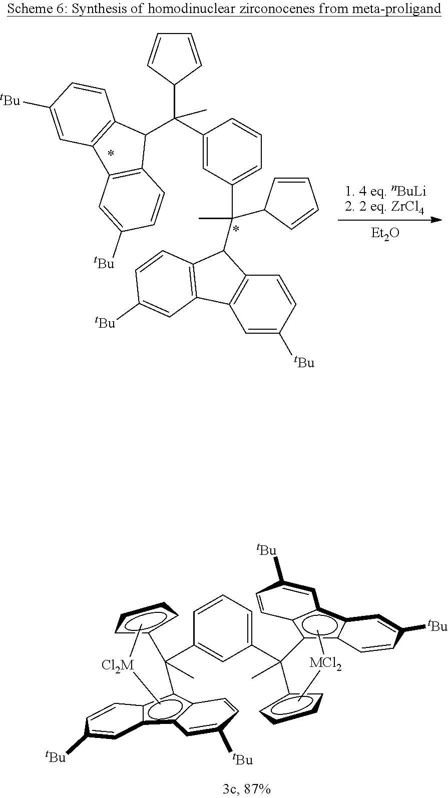

### 1,3-Benzenebis{(cyclopenta-2,4-dien-1-yl(3,6-di-tert-butyl-fluoren-9-yl)ethyl)zirconiumdichloride} (3c)

This compound was prepared as described above for 3a starting from 3,6-di-tert-butyl-9-(1-(cyclopenta-2,4-dien-1-yl)-1-phenylethyl)-9H-fluorene (0.52 g, 0.64 mmol), n-butyllithium (1.0 mL of a 2.5 M solution in hexane, 2.55 mmol, 2 equiv.) and ZrCl₄ (0.30 g, 1.27 mmol). The product was isolated as a red powder (0.63 g, 0.56 mmol, 87%).

Dinuclear hafnium complexes were obtained using the same standard salt metathesis reaction between 2 equivalents of the corresponding tetrachloride precursors (HfCl₄) and tetra anion ligands, prepared in situ via addition of four equivalents of n-butyllithium in Et₂O, in accordance with reaction Scheme 7.

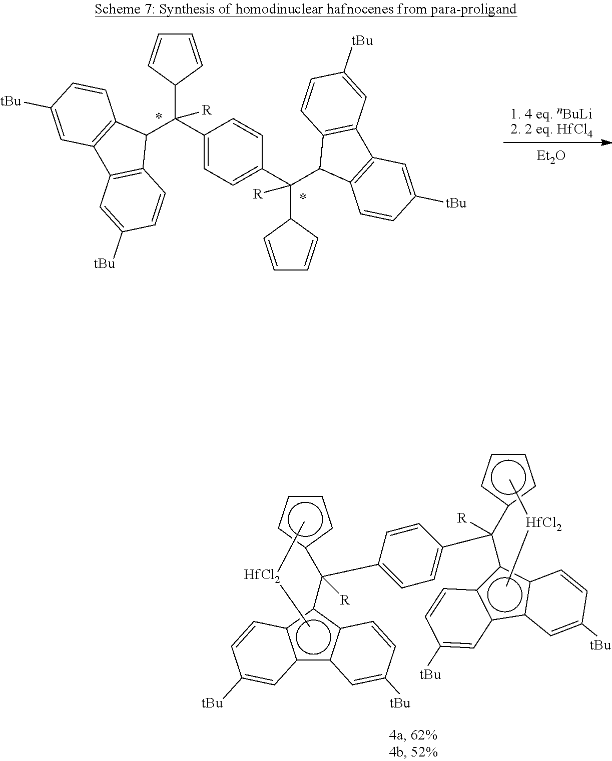

### 1,4-benzenebis{(cyclopenta-2,4-dien-1-yl(3,6-di-tert-butyl-fluoren-9-yl)ethyl)hafniumdichloride} (4a)

This compound was prepared as described above for 3a starting from 1,4-bis(cyclopenta-2,4-dien-1-yl(3,6-di-tert-butyl-fluoren-9-yl)ethyl)benzene (0.50 g, 0.61 mmol), n-butyllithium (0.98 mL of a 2.5 M solution in hexane, 2.45 mmol, 4 equiv.) and HfCl₄ (2 equiv.). The compound was recovered as a yellow powder (0.52 g, 0.38 mmol, 62%).

### 1,4-benzenebis{(cyclopenta-2,4-dien-1-yl(3,6-di-tert-butyl-fluoren-9-yl)methyl)hafniumdichloride} (4b)

This compound was prepared as described above for 3a starting from 1,4-bis(cyclopenta-2,4-dien-1-yl(3,6-di-tert-butyl-fluoren-9-yl)methyl)benzene (0.50 g, 0.61 mmol), n-butyllithium (0.98 mL of a 2.5 M solution in hexane, 2.45 mmol, 4 equiv.) and HfCl₄ (2 equiv.). The compound was recovered as a yellow powder (0.43 g, 52%).

### Example 3: Synthesis of Hetero Bis(Metallocene)s

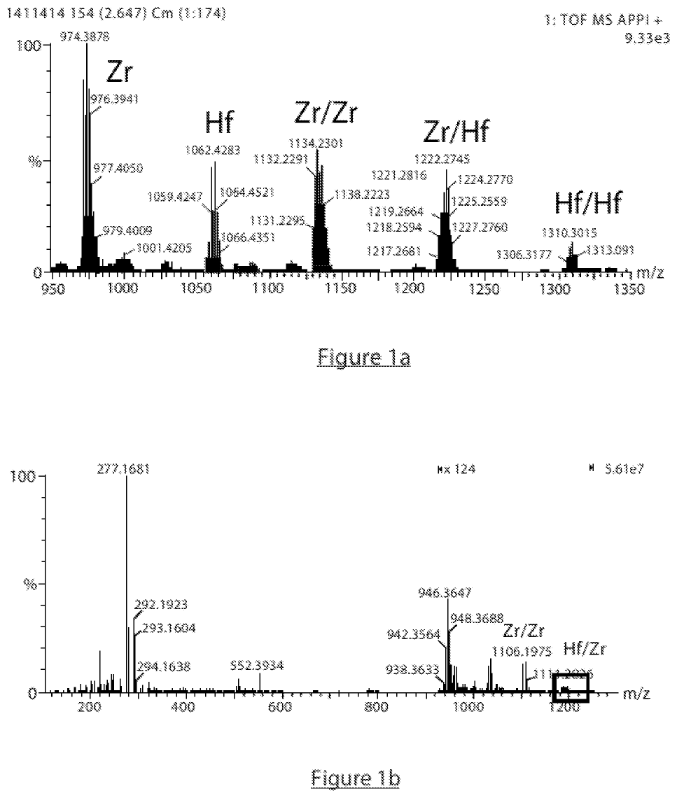

Hetero bis(metallocene) complexes were obtained using a salt metathesis reaction between one equivalent of each tetrachloride precursors (ZrCl₄ and HfCl₄) and tetra anions ligands prepared in situ via addition of four equivalents of n-butyllithium in Et₂O, in accordance with reaction Scheme 8. The results is a mixture of homo and hetero bis(metallocene) complexes. The presence of hetero bis(metallocene) complexes has been evidenced by mass spectrometry. FIG. 1 shows the mass spectrum of 5a.

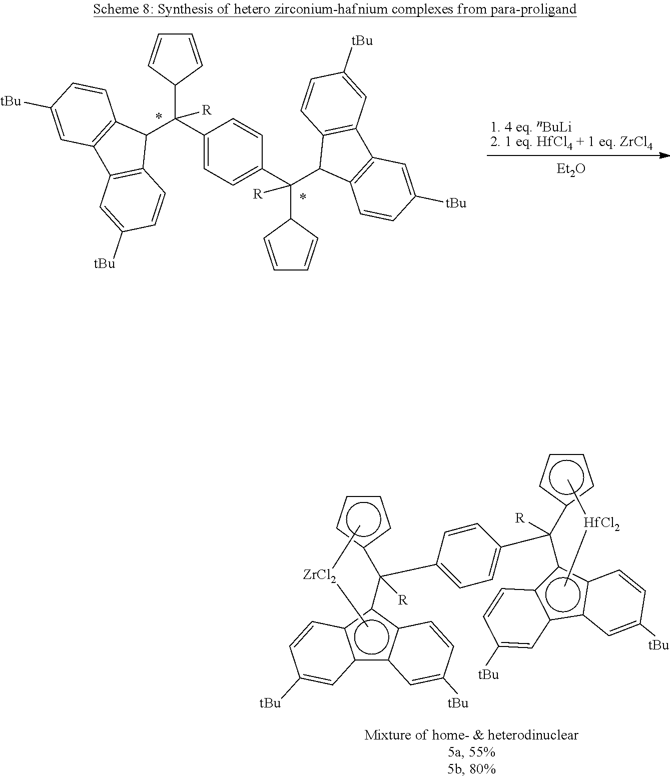

### 1,4-benzenebis{(cyclopenta-2,4-dien-1-yl(3,6-di-tert-butyl-fluoren-9-yl)ethyl)zirconiumhafniumdichloride} (5a)

This compound was prepared as described above for 3a starting from 1,4-bis(cyclopenta-2,4-dien-1-yl(3,6-di-tert-butyl-fluoren-9-yl)ethyl)benzene (1 g, 1 equiv.), n-butyllithium (2.5 M solution in hexane, 4 equiv.) and ZrCl₄ (1 equiv.) and HfCl₄ (1 equiv.). The compound was recovered as a yellow powder (0.8 g, 55%).

### 1,4-benzenebis{(cyclopenta-2,4-dien-1-yl(3,6-di-tert-butyl-fluoren-9-yl)methyl)zirconiumhafniumdichloride} (5b)

This compound was prepared as described above for 3a starting from 1,4-bis(cyclopenta-2,4-dien-1-yl(3,6-di-tert-butyl-fluoren-9-yl)methyl)benzene (1 g, 1 equiv.), n-butyllithium (2.5 M solution in hexane, 4 equiv.) and ZrCl₄ (1 equiv.) and HfCl₄ (1 equiv.). The compound was recovered as a yellow powder (1.2 g, 80%).

### Example 4: Synthesis of Mononuclear Metallocene Analogues

To investigate the catalytic properties of the dinuclear complexes according to the invention in olefin polymerisation, their mononuclear analogues were also synthesized according to reaction scheme 9. Complexes 3a′ and 3b′ were isolated in very good yield.

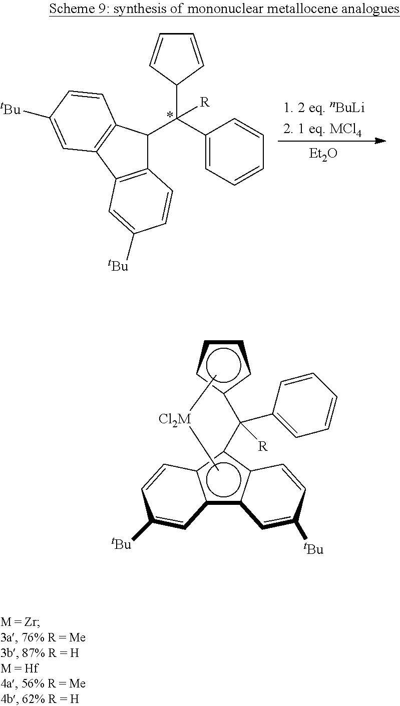

{Ph(Me)C-(3,6-^{t}Bu₂Flu)(Cp)}ZrCl₂ (3a′): This compound was prepared as described above for 3a starting from 3,6-di-tert-butyl-9-(1-(cyclopenta-2,4-dien-1-yl)-1-phenylethyl)-9H-fluorene (0.40 g 0.89 mmol), n-butyllithium (0.72 mL of a 2.5 M solution in hexane, 1.79 mmol, 2 equiv.) and ZrCl₄ (0.209 g, 0.89 mmol, 1 equiv.). The compound was isolated as a red powder (0.410 g, 0.67 mmol, 76%).

{Ph(H)C-(3,6-^{t}Bu₂Flu)(Cp)}ZrCl₂ (3b′): This compound was prepared as described above for 3a starting from 3,6-di-tert-butyl-9-(1-(cyclopenta-2,4-dien-1-yl)-1-phenylethyl)-9H-fluorene (0.43 g, 0.99 mmol), n-butyllithium (0.81 mL of a 2.5 M solution in hexane, 1.99 mmol, 2 equiv.) and ZrCl₄ (0.23 g, 0.99 mmol). The product was isolated as a red powder (0.54 g, 0.86 mmol, 87%).

{Ph(Me)C-(3,6-^{t}Bu₂Flu)(Cp)HfCl₂ (4a′): This compound was prepared as described above for 3a starting from 3,6-di-tert-butyl-9-(1-(cyclopenta-2,4-dien-1-yl)-1-phenylethyl)-9H-fluorene (0.40 g 0.89 mmol), n-butyllithium (0.72 mL of a 2.5 M solution in hexane, 1.79 mmol, 2 equiv.) and HfCl₄ (1 equiv.). The compound was isolated as a yellow powder (yield: 56%).

{Ph(H)C-(3,6-^{t}Bu₂Flu)(Cp)}HfCl₂ (4b′): This compound was prepared as described above for 3a starting from 3,6-di-tert-butyl-9-(1-(cyclopenta-2,4-dien-1-yl)-1-phenylethyl)-9H-fluorene (0.43 g, 0.99 mmol), n-butyllithium (0.81 mL of a 2.5 M solution in hexane, 1.99 mmol, 2 equiv.) and HfCl₄ (1 equiv.). The product was isolated as a yellow powder (yield: 62%).

### Example 5: Ethylene Homogenous Polymerisation

To evaluate potential cooperativity effects in these bis(metallocene) complexes for olefin polymerisation, their ethylene polymerisation behaviors were compared with those of the corresponding mononuclear analogues.

Polymerisations were performed in a 300 mL high-pressure glass reactor equipped with a mechanical stirrer (Pelton turbine) and externally heated with a double mantle with a circulating water bath. The reactor was filled with toluene (100 mL) and MAO (0.20 mL of a 30 wt-% solution in toluene) and pressurized at 5.5 bar of ethylene (Air Liquide, 99.99%). The reactor was thermally equilibrated at the desired temperature for 30 min, the ethylene pressure was decreased to 1 bar, and a solution of the catalyst precursor in toluene (ca. 2 mL) was added by syringe. The ethylene pressure was immediately increased to 5.5 bar (kept constant with a back regulator) and the solution was stirred for the desired time (typically 15 min). The temperature inside the reactor (typically 60° C.) was monitored using a thermocouple. The polymerisation was stopped by venting the vessel and quenching with a 10% HCl solution in methanol (ca. 2 mL). The polymer was precipitated in methanol (ca. 200 mL), and 35% aqueous HCl (ca. 1 mL) was added to dissolve possible catalyst residues. The polymer was collected by filtration, washed with methanol (ca. 200 mL), and dried under vacuum overnight.

Each polymerisation was repeated independently two times under the same conditions (toluene, 5.5 bar of ethylene, 60° C.). The mono and bis(metallocene) complexes were activated by treatment with a large excess of methylalumoxane ([Al/Zr]=1000). Polymerisation results are summarized in Table 2, revealing good reproducibility in terms of activity and physicochemical properties (Tₘ) of the isolated polymer.

For dinuclear hafnocene 4a, 300 equiv of BHT were added in order to increase the productivity. In fact, it is known that the “free” AlMe₃ present in MAO can form Me-bridged adducts with hafnocene that makes them catalytically inactive (see V. Busico et Al. in Macromolecules, 2009, 42, 1789). To prevent the formation of such “dormant” species, BHT can be added in situ in order to scavenge the excess of TMA.

TABLE 2
Ethylene polymerisation:

| | | PE | Productivity | Mw | | Tₘ | % C3 | % C4 | % C6 |
|---|---|---|---|---|---|---|---|---|---|
| Ref | Complex | (g) | (kg · mol⁻¹ · h⁻¹) | (g · mol⁻¹) | Mw/Mn | (° C.) | (wt %) | (wt %) | (wt %) |
| ET01 | 3b | 5.82 | 23,280 | 134,600 | 3.1 | 127.2 | 1.5 | 0.2 | 0.0 |
| ET02 | 3b | 5.20 | 20,800 | 189,200 | 3.5 | 129.0 | 0.0 | 0.2 | 0.0 |
| ET03 | 3b′ | 6.79 | 27,160 | 180,900 | 3.4 | 132.1 | 0.0 | 0.1 | 0.0 |
| ET04 | 3a | 6.20 | 24,800 | 175,100 | 3.2 | 132.3 | 0.0 | 0.1 | 0.0 |
| ET05 | 3a | 5.62 | 22,500 | 196,600 | 3.4 | 132.2 | 0.0 | 0.2 | 0.0 |
| ET06 | 3a′ | 5.64 | 22,600 | 260,400 | 3.6 | 132.1 | 0.0 | 0.1 | 0.0 |
| ET07 | 3a′ | 6.14 | 24,600 | 307,900 | 4.1 | 131.8 | 0.0 | 0.0 | 0.0 |
| ET08 | 3c | 4.96 | 19.800 | 85,000 | 3.3 | nd | 0.0 | 0.2 | 0.0 |
| ET09 | 4a | 1.53 | 6,100 | Ins. | Ins. | 132.7 | 0.0 | 0.0 | 0.0 |
| ET10 | 4a | 1.63 | 6,500 | Ins. | Ins. | 133.6 | 0.0 | 0.0 | 0.0 |

Reaction conditions: 60° C., n(Zr) = ca. 1.0 μmol, pressure = 5.5 bar ethylene, [Al]/[Zr] = 1000, time = 15 min, V = 100 mL toluene.

ET03, ET06 and ET07 are comparative examples as the polyethylene was produced by a mononuclear metallocene.

Ethylene polymerisation with these bis(metallocene) (3a-b) did not exhibit a significant difference in productivity compared to their mononuclear analogues. However, dinuclear zirconocene 3a exhibited somehow decreased molecular weight versus its mononuclear counterpart (3a′).

### Example 6: Ethylene/1-Hexene Copolymerisation

Ethylene/1-hexene copolymerisations were performed following the same procedure as described above for ethylene homopolymerisation.

Ethylene/1-hexene copolymerisations were performed in the same 300 mL high-pressure glass reactor following the same procedure as described above. Only 1-hexene (typically 2.5 mL) was introduced in the initial stages. The workup was identical.

Copolymerisation results are summarized in Table 3.

TABLE 3
Ethylene/1-hexene copolymerisation:

| | | PE | Productivity | M_{w} | | Tₘ | % C3 | % C4 | % C6 |
|---|---|---|---|---|---|---|---|---|---|
| Ref | Complex | (g) | (kg · mol⁻¹ · h⁻¹) | (g · mol⁻¹) | M_{w}/Mₙ | (° C.) | (wt %) | (wt %) | (wt %) |
| ET11 | 3b | 7.74 | 31,000 | 75,800 | 2.8 | 111.4 | 0.9 | 0.1 | 22.5 |
| ET12 | 3b | 6.70 | 26,800 | 64,000 | 2.7 | 112.2 | 0.4 | 0.1 | 19.4 |
| ET13 | 3b′ | 7.57 | 30,300 | 89,900 | 2.7 | 113.9 | 0.0 | 0.0 | 21.1 |
| ET14 | 3b′ | 7.30 | 29,200 | 96,900 | 2.9 | 108.2 | 0.0 | 0.0 | 22.7 |
| ET15 | 3a | 6.20 | 24,800 | 70,600 | 2.6 | 122.5 | 0.0 | 0.1 | 15.7 |
| ET16 | 3a | 5.62 | 22,500 | 84,300 | 3.0 | 123.8 | 0.0 | 0.0 | 23.2 |
| ET17 | 3a′ | 7.22 | 28,900 | 129,300 | 3.4 | 117.7 | 0.0 | 0.0 | 22.6 |
| ET18 | 3a′ | 6.77 | 27,100 | 132,100 | 3.3 | 118.2 | 0.0 | 0.0 | 21.3 |
| ET19 | 3c | 7.75 | 31,000 | 190,600 | 3.5 | nd | 0.0 | 0.0 | 21.3 |
| ET20 | 4a | 3.78 | 15,100 | 447,100 | 3.1 | / | 0.0 | 0.0 | 28.1 |
| ET21 | 4a | 4.34 | 17,400 | 581,500 | 4.0 | / | 0.0 | 0.0 | 29.6 |

Reaction conditions: 60° C., n(Zr) = ca. 1.0 μmol), pressure = 5.5 bar ethylene, [1-hexene]₀ = 0.2M, [Al]/[Zr] = 1000, time = 15 min, V = 100 mL toluene.

ET13, ET14, ET17 and ET18 are comparative examples as the polyethylene was produced by a mononuclear metallocene.

For ethylene/1-hexene copolymerisation, no significant cooperative effects were observed in terms of productivity or incorporation of 1-hexene compared to their mononuclear analogues.

On the other hand, dinuclear zirconocene 3a led to decreased molecular weight versus its mononuclear counterpart 3a′, in line with its abovementioned behavior in ethylene homopolymerisation.

It can be concluded that the phenylene bridged dinuclear zirconocenes according to the invention exhibit high catalytic activities in polymerisation of ethylene as well as in copolymerisation of ethylene with 1-hexene, and also a significant comonomer incorporation rate. It has been observed similar catalytic properties between the mono- and the bis(metallocene) complexes in term of activity, molecular weight of the polymer or comonomer incorporation rate. However, difference in crystallinity of the obtained polyolefin have been found.

### Example 7: Ethylene Polymerization Using Heterogenized Catalysts

### Preparation of Heterogenized Metallocenes

MAO Treatment

20 g of spray dried silica (D50=42 μm; Surface area=280 m²/g; Pore volume=1.5 ml/g; 2 wt % titanium) were introduced in 500 mL round-bottomed flask. Dry toluene (200 mL) was added and the suspension was stirred using a mechanical stirrer. MAO (30% in toluene, 42 mL) was added dropwise and the suspension was heated to 110° C. for 4 hours. The suspension was cooled down to room temperature and filtered over glass frit, washed three times with 30 mL of toluene and three times with 30 mL of dry pentane. The SMAO powder was then dried overnight under reduced pressure.

Metallocene Treatment

In a 250 ml round bottom flask, 10 g of the above-obtained SMAO were suspended in 80 mL of dry toluene. Then, 0.2 g of metallocene in 20 mL of toluene were added and the resulting suspension was stirred 2 hours at room temperature. The heterogenized metallocene was filtered over a glass frit, washed with toluene and pentane then dried overnight under reduced pressure.

### Polymerisation Conditions

Polymerization reactions were performed in a 4 L liter autoclave with an agitator, a temperature controller and inlets for feeding of ethylene and hydrogen.

The reactor was dried at 130° C. with nitrogen during one hour and then cooled to 85° C. Reactor was loaded with 2 liter of isobutane, 40 mL of 1-hexene and 3 mL of a triisobutylaluminum 10 wt % solution in n-hexane and pressurized with 23.7 bar of ethylene with 800 ppm of hydrogen. Catalyst (0.1 g) was diluted with 0.8 mL of a triisobutylaluminum 10 wt % solution in n-hexane. Polymerization started upon catalyst injection and was stopped after 60 minutes by reactor depressurization. Reactor was flushed with nitrogen prior opening and the polymer was recovered as a free flowing powder.

TABLE 4
Ethylene polymerisation

| | supported | activity | GPC | | | | | NMR |
|---|---|---|---|---|---|---|---|---|
| Ref | metallocene | g/g/h | Mn | Mw | Mz | Mw/Mn | Mz/Mw | % C6 |
| ET22 | 3b′ | 3057 | 47185 | 214116 | 588530 | 4.5 | 2.7 | 4.78 |
| ET23 | 3a′ | 1819 | 51051 | 187824 | 509281 | 3.7 | 2.7 | 5.30 |
| ET24 | 3a | 2873 | 47483 | 179788 | 593834 | 3.8 | 3.3 | 3.46 |
| ET25 | 5a | 1827 | 48549 | 159611 | 502968 | 3.3 | 3.2 | 4.54 |
| ET26 | 5b | 1070 | 38572 | 114090 | 365896 | 3.0 | 3.2 | 6.45 |
| ET27 | 3b | 923 | 47007 | 156799 | 473463 | 3.3 | 3.0 | 5.76 |
| ET28 | 4b | No activity | — | — | — | — | — | — |
| ET29 | 4a | No activity | — | — | — | — | — | — |
| ET30 | 4b′ | No activity | — | — | — | — | — | — |
| ET31 | 4a′ | No activity | — | — | — | — | — | — |

ET22, ET23, ET30 and ET31 are comparative examples as the catalyst used was a mononuclear metallocene.

ET28 and ET29 are also comparative examples as the dinuclar metallocene used did not contained Zirconium.

From the results it can be seen that 4a and 4b exhibit activity under homogeneous conditions (Tables 2 and 3) while no activity was recorder using heterogenized/supported conditions (Table 4).

### Example 8: Crystallinity of the Obtained Polymers

Crystallinity analysis have been performed on high-density polyethylene (HDPE) obtained with different catalysts including the catalyst according to the invention. Samples 1, 2 and 3 hereafter correspond to ET22, ET27 and ET26, respectively.

Sample 1 was a bimodal HDPE resin synthesized with a Zirconium mononuclear complex.

Sample 2 was a bimodal HDPE resin synthesized with a Zirconium hetero bis(metallocene) complex (Zr—Hf) according to the invention

Sample 3 was a bimodal HDPE resin synthesized with a Zirconium homo bis(metallocene) complex (Zr—Zr) according to the invention

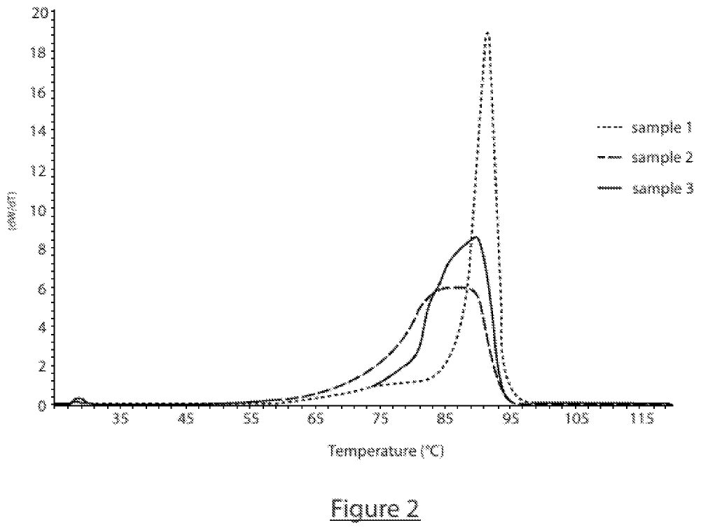

The resins of the three samples were fractionated by a Temperature Rising Elution Fractionation (TREF) process. The results are shown in FIG. 2.

Table 5 shows the results of the TRFF analysis:

TABLE 5

| | T^{a} (° C.) - | Peak 1 | Soluble fraction |
|---|---|---|---|
| Sample | Peak 1 | area | (%) (35° C.) |
| Sample 1 | 91.4 | 99.5 | 0.5 |
| Sample 2 | 87.5 | 99.3 | 0.7 |
| Sample 3 | 89.4 | 99.1 | 0.9 |

Surprisingly, from FIG. 2 it is clear that the peaks obtained for HDPE polymerised with Zirconium binuclear complex are broader than the one obtained for HDPE polymerised with Zirconium mononuclear complex. In fact there is a broadening of the peaks from monometallic to homo bis(metallocene) and hetero bis(metallocene). Such broadening reveals a bimodal structure of the polymer.

The TREF results demonstrates a synergic effect between the two components of the bis(metallocene) complex. Also, it can be seen that this synergetic effect is also shown for hetero bis(metallocene) complex Zr—Hf. This shows that the hafnium component of the bis(metallocene) complex is activated by the presence of the zirconium component, this is surprising as the hafnium mono- or bis(metallocene) complex were found to be inactive.

1.-15. (canceled)

16. A process for preparing a polyethylene resin in one or more reactors, comprising polymerizing ethylene monomer and one or more olefin co-monomer in the presence of a catalyst composition wherein the catalyst composition comprises a bis(metallocene) compound (A) having one of the following formulas: 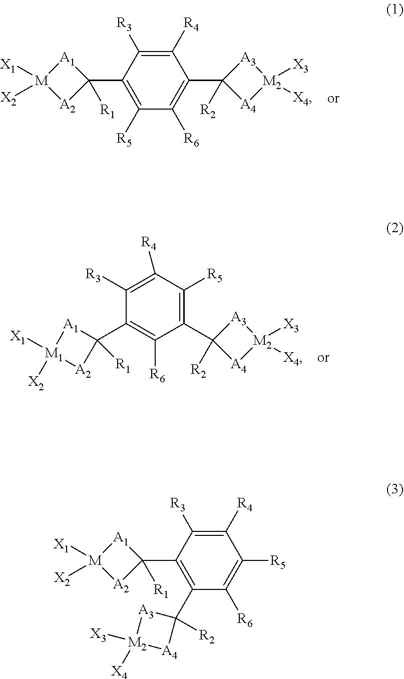
A1 and A3 are the same or different substituted or unsubstituted cyclopentadienyl rings, or substituted or unsubstituted fluorenyl rings, or substituted or unsubstituted indenyl rings, wherein if substituted, the substitutions may be independent and/or linked to form multicyclic structures
A2 and A4 are the same or different and selected from substituted or unsubstituted cyclopentadienyl rings, or substituted or unsubstituted fluorenyl rings, or substituted or unsubstituted indenyl rings.
X1, X2, X3 and X4 are independently hydrogen, halogen, hydride group, hydrocarbyl group, substituted hydrocarbyl group, alkoxide group, substituted alkoxide group, aryloxide group, substituted aryloxide group, halocarbyl group, substituted halocarbyl group, silylcarbyl group, substituted silylcarbyl group, germylcarbyl group, substituted germylcarbyl group, or both X1 and X2 and/or both X3 and X4 are joined and bound to the metal atom to form a metallacycle ring containing from 3 to 20 carbon atoms.
M1 is Zirconium
M2 is selected from Zirconium, Hafnium and Titanium
R1 and R2 are independently hydrogen or a substituted or unsubstituted aliphatic, aromatic, or cyclic group
R3, R4, R5 and R6 are independently hydrogen or a substituted or unsubstituted aliphatic, aromatic, or cyclic group.

17. The process according to claim 16 characterised in that, in the bis(metallocene) compound (A), both M1 and M2 are zirconium or M1 and M2 are different and M2 is hafnium.

18. The process according to claim 16 characterised in that in the bis(metallocene) compound (A), A1 and A3 are the same and A2 and A4 are the same so that the bis(metallocene) compound (A) shows a symmetry.

19. The process according to claim 16 characterised in that in the bis(metallocene) compound (A) one or more of the following is true:
R1 and R2 are independently hydrogen or a methyl group, and/or
R3, R4, R5 and R6 are hydrogen, and/or,
at least one of A1, A2, A3 or A4 is a fluorenyl ring.

20. The process according to claim 16 characterised in that the bis(metallocene) compound (A) is:

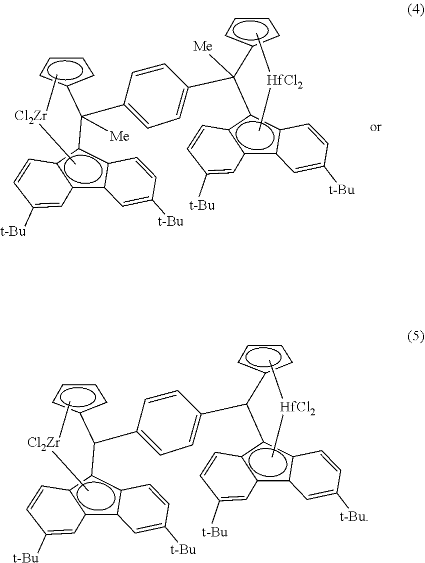

21. The process according to claim 16 characterised in that the catalyst composition further comprises a co-catalyst (B).

22. The process of claim 21 characterised in that the co-catalyst (B) is an alumoxane selected from methylalumoxane, modified methyl alumoxane, ethylalumoxane, isobutylalumoxane, or any combination thereof.

23. The process of claim 21 characterised in that the co-catalyst is an ionic activator selected from dimethylanilinium tetrakis(perfluorophenyl)borate, triphenylcarbonium tetrakis (perfluorophenyl) borate, dimethylanilinium tetrakis(perfluorophenyl)aluminate, or any combination thereof.

24. The process of claim 21 characterised in that the co-catalyst (B) is an ionic activator used in combination with a co-activator being a trialkylaluminium selected from Tri-Ethyl Aluminum (TEAL), Tri-Iso-Butyl Aluminum (TIBAL), Tri-Methyl Aluminum (TMA), and Methyl-Methyl-Ethyl Aluminum (MMEAL).

25. The process according to claim 21 characterised in that the bis(metallocene) compound (A) is or comprises a mixture of a homo bis(metallocene) wherein both M1 and M2 are Zirconium and of a hetero bis(metallocene) wherein M1 and M2 are different and further wherein M2 is Hafnium.

26. The process according to claim 16 characterized in that the process is performed in a single reactor.

27. The process according to claim 16 characterized in that the process is carried out in slurry conditions.

28. The process according to claim 16 characterized in that the polyethylene resin is a high density polyethylene (HDPE) with a density ranging from 0.940 to 0.975 g/cm³, with the density being determined according to ISO 1183.
